(19) United States
(12) Patent Application Publication
(10) Pub. No.: US 2015/0334375 A1
(43) Pub. Date: Nov. 19, 2015

(54) IMAGE PICKUP ELEMENT AND IMAGE PICKUP APPARATUS

(71) Applicant: OLYMPUS CORPORATION, Tokyo (JP)

(72) Inventor: Yuki Tokuhashi, Tokyo (JP)

(73) Assignee: OLYMPUS CORPORATION, Tokyo (JP)

(21) Appl. No.: 14/812,064

(22) Filed: Jul. 29, 2015

Related U.S. Application Data
(62) Division of application No. 14/797,978, filed on Jul. 13, 2015.
Application No. 14/797,978 is a continuation of application No. PCT/JP2013/007187, filed on Dec. 6, 2013.

(30) Foreign Application Priority Data
Jan. 15, 2013 (JP) 2013-004940

(51) Int. Cl. H04N 13/02; H04N 5/232

(52) U.S. Cl. CPC H04N 13/0239; H04N 5/23293

(57) ABSTRACT

An image pickup element includes: light-receiving elements, a pair thereof in a row direction outputting pixel signals forming a pair of captured images that have parallax of an object, a group of light-receiving elements being formed by a central light-receiving element being disposed between the light-receiving elements in the pair; a microlens that refracts light from the object and causes the light-receiving elements to receive the light; a color filter that transmits light in accordance with color and is one of R, G, and B for each pair of light-receiving elements, R/G or B/G alternating in the row direction, and a different color being disposed for the pair and the central light-receiving element; and wiring, between the light-receiving elements in the row direction, that transmits I/O signals of the light-receiving elements. The microlens is a cylindrical lens that extends in the column direction and covers the group of light-receiving elements.

### CROSS-REFERENCE TO RELATED APPLICATION

The present application is a Divisional Application of U.S. application Ser. No. 14/797,978 filed on Jul. 13, 2015, which is a Continuation Application based on International Application PCT/JP2013/007187 filed on Dec. 6, 2013, which in turn claims priority to Japanese Patent Application No. 2013-4940 filed on Jan. 15, 2013, the entire disclosures of these applications being incorporated herein by reference in their entirety.

### TECHNICAL FIELD

This disclosure relates to an image pickup element provided with pairs of light-receiving elements that are arranged in a matrix, receive light from an object, and output pixel signals forming a pair of captured images of the object. This disclosure also relates to an image pickup apparatus provided with this image pickup element.

### BACKGROUND

An image pickup element provided with a left/right pair of light-receiving elements for each microlens in a matrix of microlenses is one known structure for using a single image pickup element to capture a pair of object images having parallax. With a color filter, this image pickup element selectively causes light from the object that passes through the microlenses to reach the light-receiving elements. A pair of light-receiving elements corresponds to a pair of pixels (picture element) that form a pair of captured images. A pixel signal that forms the left-eye captured image is output from the left-eye light-receiving element, and a pixel signal that forms the right-eye captured image is output from the right-eye light-receiving element. The pixel signals correspond to a gradation of color. The pair of captured images is, for example, used for stereoscopic image display. An example of such an image pickup element is disclosed in JP 2003-523646 A (PTL 1).

### CITATION LIST

### Patent Literature

PTL 1: JP 2003-523646 A

Due to its structure, the above-mentioned image pickup element has problems such as a reduction in resolution or in the stereoscopic effect of a stereoscopic image. When the numerical aperture on the image side of the image pickup lens is large and the F-number is small, the inclination of light rays passing through the microlenses increases, and when light enters into the corresponding pair of light-receiving elements, light also leaks into the pairs of light-receiving elements of other picture elements that are adjacent to the left and right. For example, right-eye light that should be received by a right-eye light-receiving element is received by the left-eye light-receiving element of an adjacent pair of light-receiving elements, and the left-eye light that should be received by a left-eye light-receiving element is received by the right-eye light-receiving element of an adjacent pair of light-receiving elements. This may lead to a reduction in quality of the stereoscopic image, such as a discrepancy in hue or brightness between the left/right pair of captured images due to the pixel signals becoming mixed between a left/right pair of captured images, or a reduction in stereoscopic effect or resolution due to the occurrence of crosstalk.

Therefore, it could be helpful to provide an image pickup element that can prevent a reduction in quality of a stereoscopic image and to provide an image pickup apparatus that includes this image pickup element.

### SUMMARY

An image pickup element according to one aspect includes: a plurality of light-receiving elements, arranged in a row direction and a column direction, that receive light from an object, a pair of light-receiving elements forming a pair in the row direction corresponding to a horizontal direction of the object and outputting pixel signals forming a pair of captured images that have parallax of the object; a microlens that refracts light from the object and causes the light-receiving elements to receive the light; a color filter, between the microlens and the light-receiving elements, that transmits light in accordance with color and has one color among Red (R), Green (G), and Blue (B) for each pair of light-receiving elements, two colors R and G or two colors B and G alternating in the row direction; and wiring, between the light-receiving elements in the row direction, that transmits an input signal or an output signal of the light-receiving elements.

The color filter may be arranged so that two colors R and G or two colors B and G are adjacent in the column direction.

Furthermore, the color filter may have a portion where the same colors are adjacent in the column direction.

The wiring may be disposed between pairs of the light-receiving elements in the row direction. The wiring may also be made of copper.

An image pickup apparatus according to another aspect includes the above image pickup element and a display configured to display a stereoscopic image based on the above pair of captured images. This image pickup apparatus may further include an amplifier configured to amplify the pixel signals output by the light-receiving elements by an amplification factor in accordance with color of the color filter and to output the amplified pixel signals to the display.

The disclosed embodiments can prevent a reduction in quality of a stereoscopic image.

### BRIEF DESCRIPTION OF THE DRAWINGS

In the accompanying drawings:

FIG. 1 is a block diagram illustrating the structure of an image pickup apparatus according to Embodiment 1;

FIG. 2 is a schematic plan view of an image pickup element;

FIGS. 3A and 3B are cross-sectional views of the image pickup element;

FIG. 4 is a schematic plan view of the image pickup element;

FIG. 5 illustrates an example of a color filter in Embodiment 1;

FIG. 6 illustrates the wiring material and the transmittance of object light;

FIG. 7 illustrates an example of a color filter in Embodiment 2;

FIG. 8 illustrates an example of a color filter in Embodiment 3;

FIG. 9 illustrates an example of a color filter in Embodiment 4;

FIG. 10 illustrates a modification to Embodiment 1; and

FIG. 11 illustrates another modification to Embodiment 1.

### DETAILED DESCRIPTION

The following describes the disclosed embodiments.

### Embodiment 1

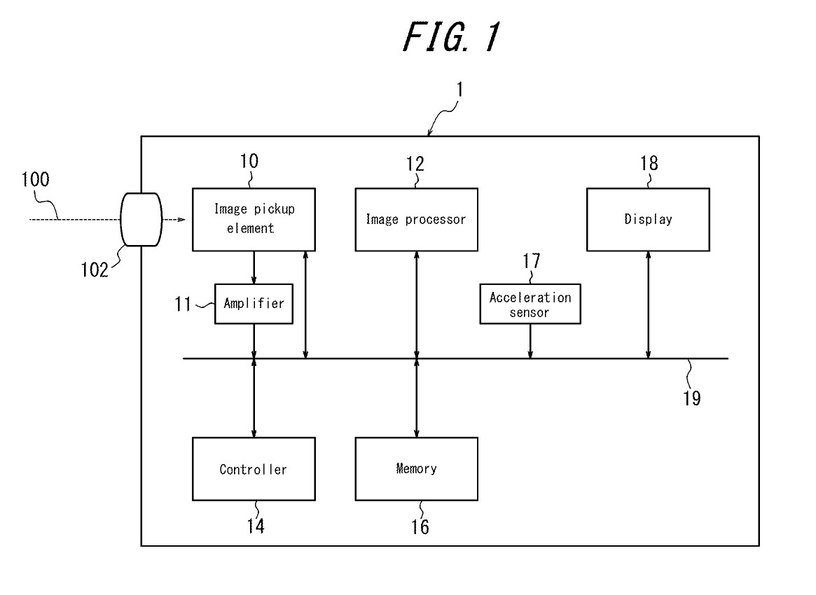

FIG. 1 is a block diagram illustrating the structure of an image pickup apparatus according to Embodiment 1. Based on light 100 from the object of shooting (object light), the image pickup apparatus 1 captures a pair of images having parallax for displaying a stereoscopic image. The image pickup apparatus 1 includes an image pickup lens 102, an image pickup element 10, an amplifier 11, an image processor 12, a controller 14, a memory 16, and a display 18. The image pickup element 10, amplifier 11, image processor 12, controller 14, memory 16, an acceleration sensor 17, and the display 18 are connected to a bus 19 and can transmit and receive a variety of signals to and from each other.

Upon object light 100 entering via the image pickup lens 102, the image pickup element 10 captures a left-eye image and a right-eye image having parallax based on the object light 100 and outputs pixel signals forming each captured image. Each captured image is formed by a matrix of pixels. The number of pixels constituting one frame of a captured image is, for example, from 640×480 pixels to 4000×3000 pixels (the number of pixels in one frame and the aspect ratio, however, are not limited to this range). The image pickup element 10 is a Complementary Metal Oxide Semiconductor (CMOS) or Charge Coupled Device (CCD) having a light-receiving element disposed in correspondence with each pixel, generates a pixel signal via the light-receiving elements, and outputs the pixel signal. The pixel signal is, for example, generated and output frame by frame. The pixel signal is, for example, a signal indicating a gradation of the colors Red (R), Green (G), and Blue (B) for each pixel. The pixel signal may also, for example, be a digital signal yielded by A/D conversion of the output signal from the light-receiving elements.

The amplifier 11 amplifies the pixel signal output by the image pickup element 10 and outputs the result to the bus 19. As described in detail below, the amplifier 11 amplifies the pixel signal by a different amplification factor in accordance with the color of the pixel signal. The amplifier 11 may be provided inside the image pickup element 10, inside the image processor 12, or at another position within the image pickup apparatus 1.

The image processor 12 performs predetermined image processing, such as color and luminance correction, distortion correction, and the like, as well as data compression and expansion on captured image data including the pixel signals for one frame. The image processor 12 for example performs image processing on the captured image data for each frame. At the time of image processing, the image processor 12 may acquire the vertical direction, the amount of shaking, and the like of the image pickup element 1 from the acceleration sensor 17 and perform image processing based on these data. The image processor 12 may, for example, be a processor such as a Digital Signal Processor (DSP) or an Application Specific Integrated Circuit (ASIC).

The memory 16 is a frame memory storing captured image data before and/or after image processing. The memory 16 is, for example, Static Random Access Memory (SRAM) or Dynamic RAM (DRAM). The memory 16 may include a data read/write device for a variety of storage media such as a hard disk, portable flash memory, or the like.

The display 18 displays a stereoscopic image based on the captured image data. The display 18 for example includes a liquid crystal display (LCD) and a control circuit for the LCD, the LCD being provided with a polarization filter corresponding to the parallax between the left and right eyes. The display 18 displays the left and right captured image data having parallax so as to display a stereoscopic image that the user can perceive stereoscopically.

The controller 14 sends control signals to the image pickup element 10, amplifier 11, image processor 12, memory 16, and display 18 and comprehensively controls operations of the image pickup apparatus 1. The controller 14 is, for example, a microcomputer.

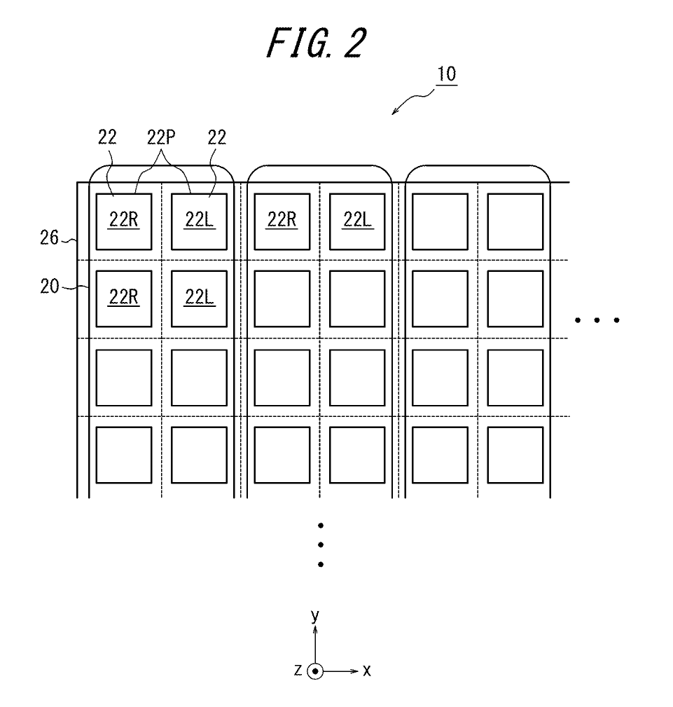

FIG. 2 is a schematic plan view of the image pickup element 10. The image pickup element 10 includes a matrix of light-receiving elements 22. Here, the direction of the x-axis (row direction) corresponds to the horizontal direction of the captured image, and the direction of the y-axis (column direction) corresponds to the vertical direction of the captured image. The direction of the z-axis perpendicular to the page corresponds to the direction of the optical axis of the object light 100. The light-receiving elements 22 form pairs of light-receiving elements 22P in the row direction, i.e. in the horizontal direction of the captured image. The pair of light-receiving elements 22P includes a light-receiving element 22L and a light-receiving element 22R. For a pair of captured images having parallax for displaying a stereoscopic image, the light-receiving element 22L generates and outputs a pixel signal forming a left-eye captured image, and the light-receiving element 22R generates and outputs a pixel signal forming a right-eye captured image. In the illustrated example, light-receiving elements 22R and 22L that are adjacent in the row direction form a pair of light-receiving elements 22P, and pairs of light-receiving elements 22P adjacent in the column direction form columns. Hereinafter, the term “light-receiving element 22” is used when referring to a light-receiving element without distinguishing left from right, whereas the term “light-receiving elements 22R and 22L” is used when distinguishing left from right.

The image pickup element 10 includes a color filter 26 disposed on the light-receiving elements 22. The color filter 26 has one of the colors of R (Red), G (Green), and B (Blue) for each light-receiving element 22, and light corresponding to that color is selectively transmitted and caused to reach the corresponding light-receiving element 22. The arrangement of colors in the color filter 26 is described below in detail.

The image pickup element 10 includes microlenses 20 disposed above the light-receiving elements 22. The microlenses 20 may be cylindrical lenses or spherical lenses. In other words, each microlens may be a cylindrical lens extending in the column direction and covering a pair of the light-receiving elements that form a pair in the row direction. Furthermore, the cylindrical lens may cover (i) a pair of light-receiving elements that form a pair in the row direction with an additional light-receiving element therebetween and (ii) the additional light-receiving element. Each microlens may also be a spherical lens covering a pair of light-receiving elements that are adjacent in the column direction and are associated with the same color of the color filter. The case of cylindrical lenses is illustrated here. The cylindrical lenses are disposed so that each cylindrical lens curves in the row direction while extending in the column direction to cover one pair of light-receiving elements 22P in the row direction and a plurality of pairs of light-receiving elements 22P in the column direction.

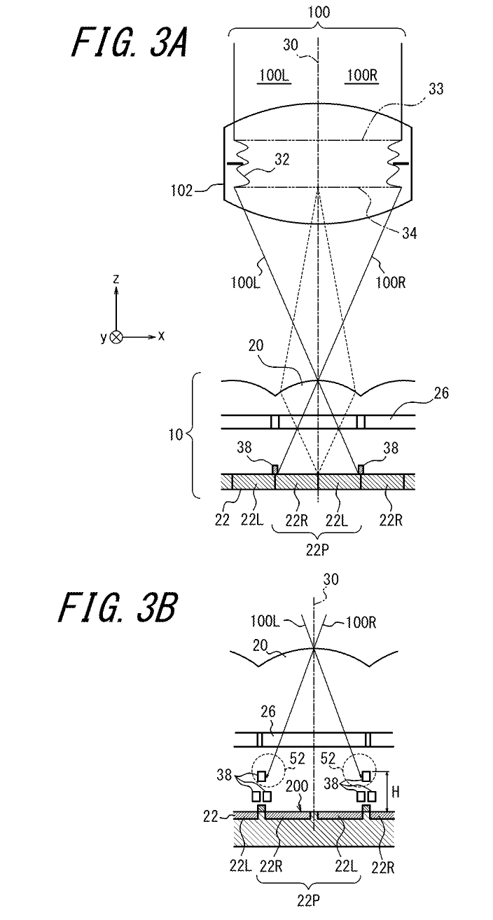

FIG. 3A is a cross-sectional view along the optical axis direction (z-axis direction) of the image pickup element 10. The object light 100 enters the image pickup element 10 via the image pickup lens 102. The object light 100 passes through the image pickup lens 102 via an entrance pupil 33 and an exit pupil 34 that have a diameter corresponding to a diaphragm 32. The object light 100 that has passed through the image pickup lens 102 is collected on the microlens 20, and light of the wavelength corresponding to the color of the color filter 26 reaches the light-receiving element 22. In this way, light that is one of the colors of R, G, and B strikes the light-receiving elements 22L and 22R of the pair of light-receiving elements 22P and forms an image of the object.

Looking at each pair of light-receiving elements 22P, within the object light 100, the light beam 100L on the left side with respect to the optical axis 30 strikes the left-eye light-receiving element 22L, and the light beam 100R on the right side strikes the right-eye light-receiving element 22R. The light-receiving element 22L generates and outputs a pixel signal of a pixel forming the left-eye captured image. On the other hand, the light-receiving element 22R generates and outputs a pixel signal of a pixel forming the right-eye captured image. The light-receiving elements 22 are, for example, photodiodes included in a CMOS or CCD.

Wiring 38 that transmits an input signal or an output signal of the light-receiving elements 22 is disposed between pairs of light-receiving elements 22P. The wiring is, for example, disposed in layers. As illustrated in the partial enlargement in FIG. 3B, in accordance with the height H, from a light-receiving surface 200 of the light-receiving element 22, of the layers of wiring 38, the wiring 38 blocks (52) leak light from light beams 100L and 100R that leak from the light-receiving elements 22L and 22R and strike an adjacent pair of light-receiving elements 22P.

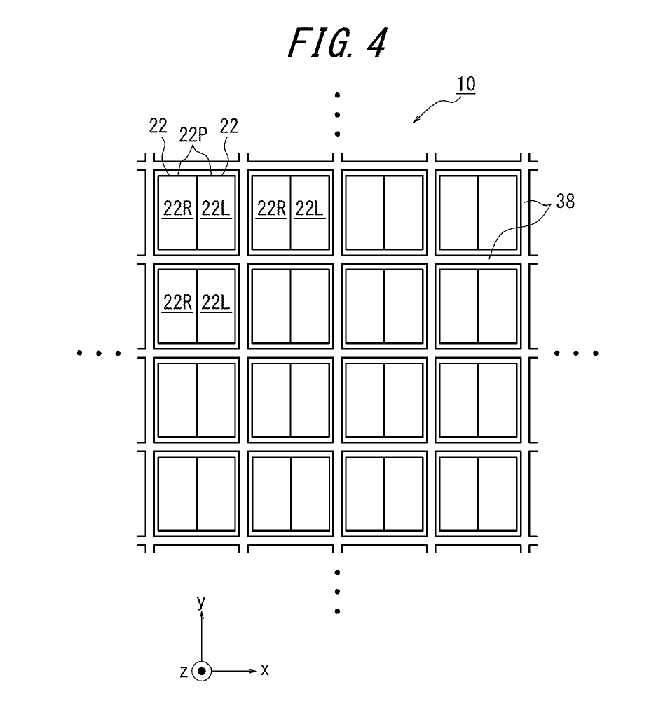

As illustrated in the schematic plan view of FIG. 4, the wiring 38 is also disposed in the x-y plane of the image pickup element 10, between pairs of light-receiving elements 22P in the row direction (x-axis direction). As a result, leak light between pairs of light-receiving elements in the row direction can be appropriately blocked. The wiring 38 may be provided in the row direction for every two or more pairs of light-receiving elements 22P or for each set of a random number of pairs of light-receiving elements 22P. Furthermore, in each pair of light-receiving elements 22P, the wiring 38 may be provided between the light-receiving elements 22R and 22L.

The wiring 38 may also be provided between pairs of light-receiving elements 22P in the column direction (y-axis direction). As a result, leak light between pairs of light-receiving elements in the column direction can be appropriately blocked. The wiring 38 may be provided in the column direction for every two or more pairs of light-receiving elements 22P or for each set of a random number of pairs of light-receiving elements 22P.

With the effects of such wiring 38, leak light between pairs of light-receiving elements 22P or between light-receiving elements 22 can be blocked to a certain degree, even without providing an additional structure for light blockage such as an aluminum dividing wall. There is a trade-off, however, between the function of blocking leak light and the tendency for a reduction in the height of the wiring 38 as a result of recent progress in fine wiring techniques. The wiring 38 also has different transmittance depending on the material thereof. For example, wiring 38 has higher transmittance when made from copper than from aluminum, and the function of blocking leak light is correspondingly reduced. Therefore, in Embodiment 1, the negative effect of leak light is further reduced in the following way.

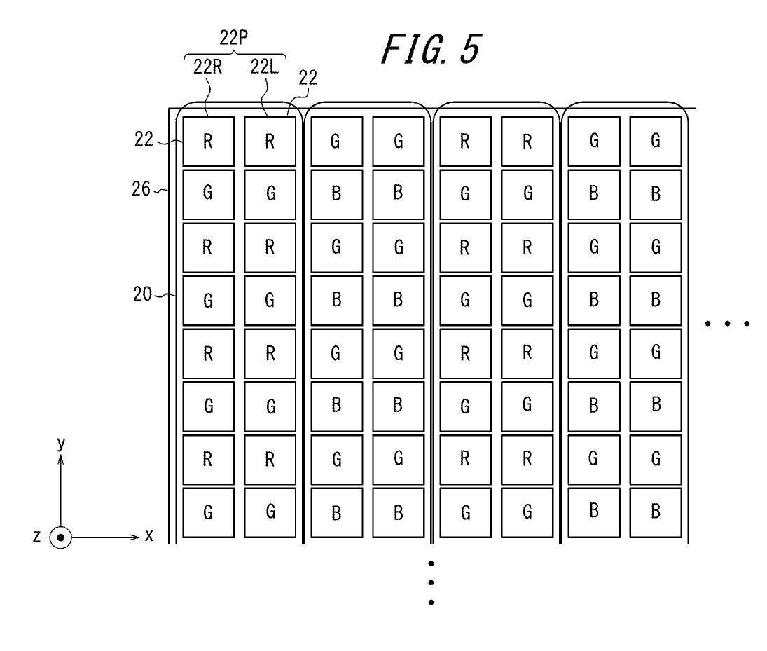

FIG. 5 illustrates an example of the color filter 26 in Embodiment 1. In FIG. 5, the squares correspond to the positions of light-receiving elements 22. In the illustrated example, the microlenses 20 are cylindrical lenses. In Embodiment 1, the color filter 26 has one of the colors of R, G, and B for each pair of light-receiving elements 22P. In other words, the same color is associated with the light-receiving elements 22R and 22L in each pair of light-receiving elements 22P. Additionally, colors are disposed so that either R and G are associated alternately or B and G are associated alternately with pairs of light-receiving elements 22P in the row direction. Furthermore, the color filter 26 is arranged so that either the two colors R and G or the two colors B and G are adjacent in the column direction.

This color filter 26 has the same color for each pair of light-receiving elements 22P. Therefore, when looking at each pair of light-receiving elements 22P, even if light leaking from the light-receiving element 22L enters the light-receiving element 22R or light leaking from the light-receiving element 22R enters the light-receiving element 22L, the light-receiving element 22R or 22L receives leak light of the same color as that of the light that is originally intended to be received. Therefore, a color discrepancy between the left/right pair of captured images can be prevented.

In the color filter 26, colors are arranged so that R and G are alternately associated, or so that B and G are alternately associated, with pairs of light-receiving elements 22P in the row direction. Therefore, even if the light-receiving elements 22L and 22R in each pair of light-receiving elements 22P receive leak light from an adjacent pair of light-receiving elements 22P, the light-receiving elements 22L and 22R both receive leak light of the same color. Accordingly, the color shift due to receiving light of a different color than the originally intended color is equivalent between the left/right pair of captured images. Therefore, a color discrepancy between the left/right pair of captured images can be prevented.

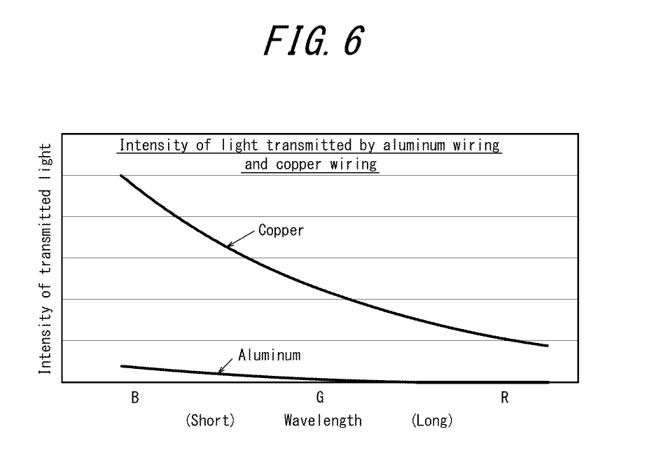

With reference to FIG. 6, the following describes the materials of the wiring 38 and the transmittance of object light 100 in Embodiment 1. FIG. 6 is a graph in which the horizontal axis represents the wavelength of object light 100 and the vertical axis represents the intensity of light transmitted by the wiring 38. As illustrated in FIG. 6, regardless of whether the wiring 38 is made of copper or aluminum, the transmittance of the wiring 38 is higher as the wavelength of the object light 100 is shorter, and the intensity of transmitted light increases in the order of R, G, and B. In other words, light in which B is dominant is transmitted more easily by the wiring 38 than light in which G is dominant. Furthermore, light in which G is dominant is transmitted more easily by the wiring 38 than light in which R is dominant. These relationships are more prominent when the wiring 38 is made of copper. Taking these relationships into consideration, for example in an area struck by light in which B is dominant, the magnitude of the color shift decreases in the following order of combinations of the color of the color filter 26 through which the light passes and the originally intended color of the light-receiving element 22 that the light strikes:

1) the case of light passing through B and being received by a light-receiving element 22 for R;
2) the case of light passing through G and being received by a light-receiving element 22 for R;
3) the case of light passing through G and being received by a light-receiving element 22 for B; and
4) the case of light passing through R and being received by a light-receiving element 22 for G.
As a result, in such an area, there is a tendency for R to become more dominant than the originally intended color of the captured image. In Embodiment 1, however, B and R are not adjacent in either the row direction or the column direction. Hence, case 1) above, in which the amount of color shift is the largest, can be avoided. It is thus possible to minimize the color shift due to receiving light of a different color than the originally intended color. In addition, since the color shift is equivalent between the left/right pair of captured images, a color discrepancy between the left/right pair of captured images can be prevented.

In the color filter 26, colors are arranged so that R and G are alternately associated, or so that B and G are alternately associated, with pairs of light-receiving elements 22P in the row direction, i.e. colors are arranged so that R and B are not adjacent in the row direction. Therefore, a good captured image can be obtained when amplifying the pixel signal by a different amplification factor in accordance with the color of the pixel signal. Since the transmittance of light passing through the color filter 26 differs in accordance with color, the amount of light received by each light-receiving element 22 differs in accordance with color. Therefore, the intensity of the pixel signal output by each light-receiving element 22 differs in accordance with color. Accordingly, the amplifier 11 that amplifies the pixel signal can maintain good coloring of the captured image by amplifying the pixel signals by different amplification factors in accordance with the color. For example, when the ratio of transmittance of R, G, and B light is 1/3:1/2:1, the intensity of the R, G, and B pixel signals obtained for the same amount of light can be made uniform by setting the ratio of the amplification factors to 3:2:1.

When looking at pairs of light-receiving elements 22P in the row direction in Embodiment 1, the relationship between the color of leak light and the originally intended color of the light-receiving element is one of the following:

1) the case of R or B leak light striking a light-receiving element for G; and
2) the case of G leak light striking a light-receiving element for R or B.
In case 1), if R light that has a transmittance of 1/3 is amplified by the amplification factor of two for G, then as compared to when the leak light from R is converted as is into a signal, a signal with 2/3 intensity is overlaid on the G pixel signal. If B light that has a transmittance of one is amplified by the amplification factor of two for G, then as compared to when the leak light from B is converted as is into a signal, a signal with double intensity is overlaid on the G pixel signal. On the other hand, in case 2), if G light that has a transmittance of 1/2 is amplified by the amplification factor of three for R, then as compared to when the leak light from G is converted as is into a signal, a signal with 3/2 intensity is overlaid on the R pixel signal. If G light that has a transmittance of 1/2 is amplified by the amplification factor of one for B, then as compared to when the leak light from G is converted as is into a signal, a signal with 1/2 intensity is overlaid on the B pixel signal. In this way, in Embodiment 1, the variation in intensity of the pixel signal ranges from a factor of 1/3 to 3/2.

In other words, when the amounts of incident RGB light are equivalent, then the ratio of the amount of light leaking from R, with a transmittance of 1/3, to G in case 1) to the amount of light leaking from G, with a transmittance of 1/2, to R in case 2) is 1/3:1/2, and if the amplification factor of RGB is 1:1:1, then the signal increase due to leak light in the G and R pixels is the same as the transmittance ratio, i.e. 1/3:1/2. If the RGB amplification factor, however, is 3:2:1 as in this example, then the pixel signal due to leak light from R to G is amplified by the amplification factor of two for G, and the pixel signal due to leak light from G to R is amplified by the amplification factor of three for R. Therefore, the ratio of the pixel signal increase due to leak light from R to G in a G pixel in case 1) to the pixel signal increase due to leak light from G to R in an R pixel in case 2) becomes 2/3:3/2, which is a larger difference than the transmittance. Similarly, the ratio of the amount of light leaking from B to G to the amount of light leaking from G to B is 1:1/2, yet since the ratio of the amplification factors is 2:1, the ratio of the pixel signal increase due to leak light from B to G in a G pixel to the pixel signal increase due to leak light from G to B in a B pixel becomes 2:1/2. In this way, even if amplification factors are set so that the RGB pixel signal output is equivalent for an equivalent amount of incident RGB light, the effects of leak light are not equivalent, and misalignment occurs in the signal output. In Embodiment 1, the increase due to leak light has a maximum difference of a factor of four.

As a comparative example, the case of R and B being adjacent in the row direction is now considered. If R leak light strikes a light-receiving element for B, and the R light that has a transmittance of 1/3 is amplified by the amplification factor of one for B, then as compared to when the leak light from R is converted as is into a signal, a signal with 1/3 intensity is overlaid on the B pixel signal. Conversely, if B leak light strikes a light-receiving element for R, and the B light that has a transmittance of one is amplified by the amplification factor of three for R, then as compared to when the leak light from B is converted as is into a signal, a signal with triple intensity is overlaid on the R pixel signal. Accordingly, the variation in intensity of the pixel signal is expanded to range from a factor of 1/3 to 3. Therefore, as compared to this case, the color filter 26 in Embodiment 1 can reduce the variation in intensity of the pixel signal (the difference from the effect of leak light) to a smaller range. In other words, the ratio of leak light from R to B to leak light from B to R is 1/3:1, yet the ratio of the signal increase due to leak light from R to B in a B pixel to the signal increase due to leak light from B to R in an R pixel becomes 1/3:3, yielding a difference of a factor of nine in the signal increase due to leak light.

According to the above structure, when the microlenses 20 are cylindrical lenses, a color discrepancy between the left/right pair of captured images can be prevented, even when the amount of leak light between light-receiving elements 22 in the row direction is relatively larger than the amount of leak light between light-receiving elements 22 in the column direction. Since the color filter 26 is arranged so that either the two colors R and G or the two colors B and G are adjacent in the column direction, however, a similar effect is also achieved with respect to leak light between light-receiving elements 22 in the column direction.

### Embodiment 2

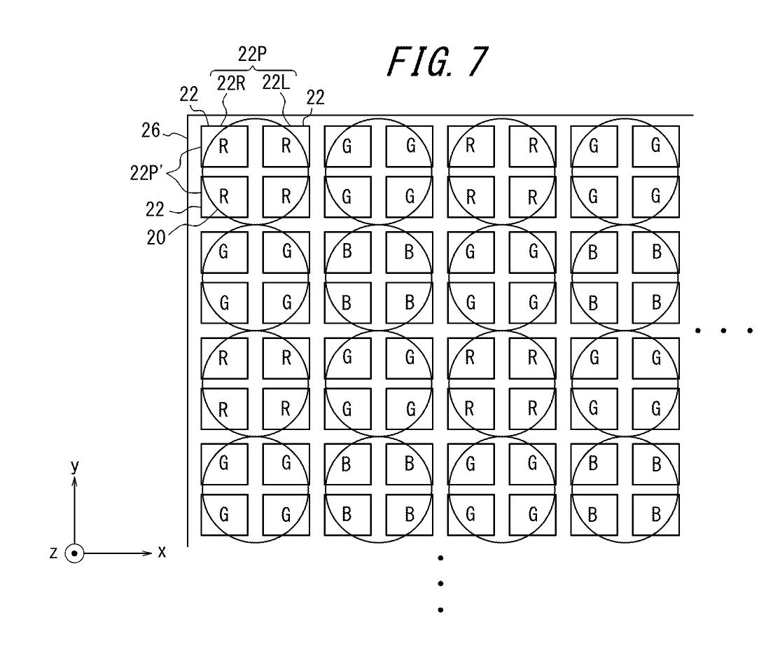

FIG. 7 illustrates an example of the color filter 26 in Embodiment 2. In FIG. 7, the squares correspond to the light-receiving elements 22.

In Embodiment 2, the microlens 20 corresponds to two pairs 22P of light-receiving elements adjacent in the column direction, i.e. to a total of four light-receiving elements 22 measuring two in the row direction and two in the column direction, and has a spherical lens that is curved in the row direction and the column direction. In Embodiment 2, the light-receiving elements 22 form pairs not only in the row direction, but also form pairs of light-receiving elements 22P′ in the column direction. In Embodiment 2, the image pickup element 10 can capture pairs of images having parallax in the column direction as well. For example, when the image pickup apparatus 1 is rotated 90° either to the left or the right with respect to an object of shooting to capture images with the row direction and column direction of the image pickup element 10 reversed with respect to the horizontal direction of the object, then the image processor 12 can detect the vertical direction of the image pickup element 10 and generate a pair of captured images using the pixel signals from the pairs of light-receiving elements 22P′ corresponding to the horizontal direction of the object. The remaining structure of the image pickup apparatus 1 is the same as in Embodiment 1.

In Embodiment 2, each pair of light-receiving elements 22P in the row direction has one of the colors of R, G, and B. Also, either R and G, or B and G, are arranged alternately in the row direction, and either R and G alternately correspond or B and G alternately correspond to the pairs of light-receiving elements 22P in the row direction. Furthermore, either the two colors R and G or the two colors B and G are adjacent in the column direction. Portions in which the same colors are adjacent in the column direction are also provided.

In Embodiment 2, first, when generating a pair of captured images using pixel signals from pairs of light-receiving elements 22P in the row direction, a color discrepancy between the left/right pair of captured images can be prevented through similar effects as in Embodiment 1. Furthermore, due to the color filter 26 having portions in which the same colors are adjacent in the column direction (i.e. the portions corresponding to the pairs of light-receiving elements 22P′), in the light-receiving elements 22 of the corresponding portions, the leak light from an adjacent light-receiving element 22 in the column direction has the same color as the originally intended color. Accordingly, the negative effect of color mixing between pixels in the vertical direction of the captured image can be reduced, and a reduction in quality of each captured image can be prevented. In addition, even when the row direction and column direction are reversed so as to generate a pair of captured images with the pixel signals from pairs of light-receiving elements 22P′ in the column direction, a color discrepancy between the left/right pair of captured images can be reduced, and the negative effect of color mixing between pixels in the vertical direction of the captured image can be reduced.

### Embodiment 3

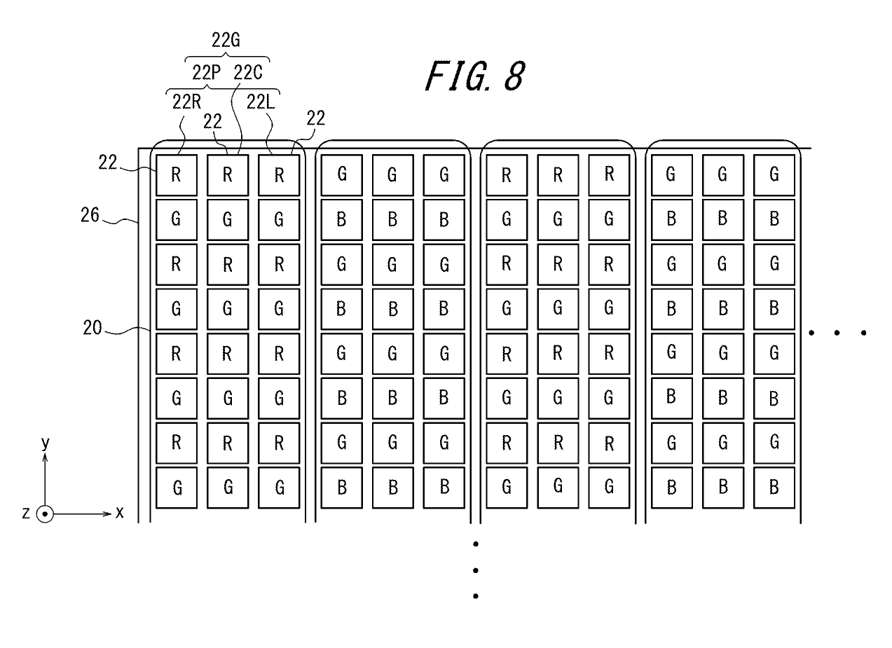

FIG. 8 illustrates an example of the color filter 26 in Embodiment 3. In FIG. 8, the squares correspond to the light-receiving elements 22.

In Embodiment 3, among three light-receiving elements 22 adjacent in the row direction, left/right light-receiving elements 22R and 22L form a pair of light-receiving elements 22P and sandwich a central light-receiving element 22C therebetween. For the sake of convenience, the light-receiving element 22C and the pair of light-receiving elements 22P sandwiching the light-receiving element 22C are referred to as a group of light-receiving elements 22G. Each microlens 20 is a cylindrical lens that curves in the row direction while extending in the column direction to cover a group of light-receiving elements 22G in the row direction and a plurality of groups of compared to the left/right pair of light-receiving elements 22P, the central light-receiving element 22C within the group of light-receiving elements 22G receives object light 100, from near the center of the image pickup lens 102, with smaller aberration and distortion. Taking advantage of this fact, the image processor 12 uses the pixel signal from the light-receiving element 22C to adjust the aberration and distortion of the pair of captured images formed by the pixel signals from the pair of light-receiving elements 22P. The remaining structure of the image pickup apparatus 1 is the same as in Embodiment 1.

In Embodiment 3, in the row direction, the color filter 26 has one of the colors of R, G, and B for each group of light-receiving elements 22G that includes the pair of light-receiving elements 22P, and either R and G, or B and G, are arranged alternately in the row direction. Additionally, either R and G are associated alternately or B and G are associated alternately with groups of light-receiving elements 22G, which include the pairs of light-receiving elements 22P, in the row direction. Furthermore, either the two colors R and G or the two colors B and G are adjacent in the column direction.

Embodiment 3, in addition to achieving the same effects as Embodiment 1, can improve the quality of a stereoscopic image by correcting for the effect of aberration and distortion of the image pickup lens 102.

### Embodiment 4

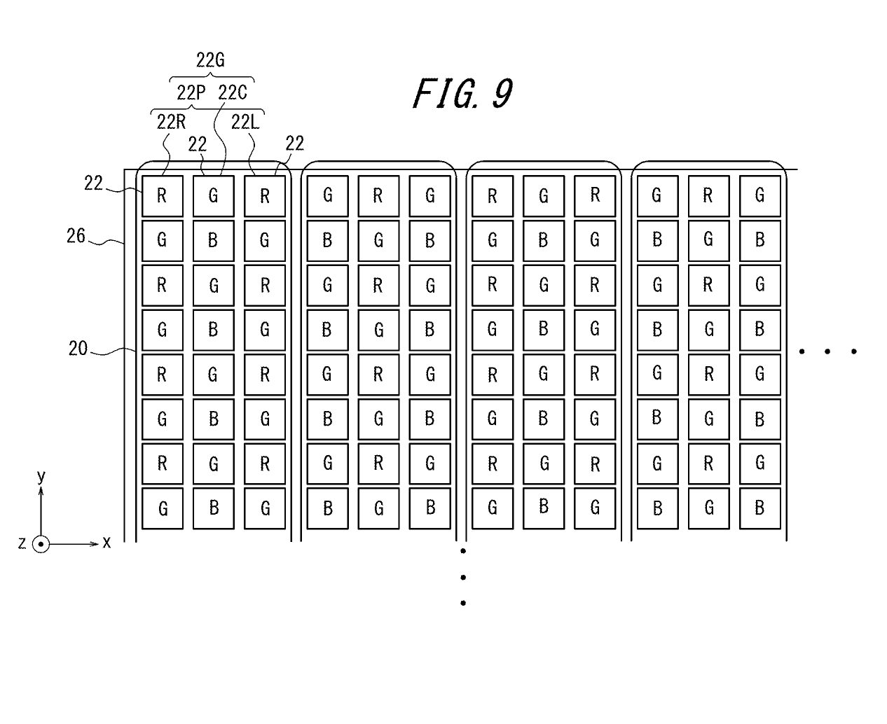

FIG. 9 illustrates an example of the color filter 26 in Embodiment 4. In FIG. 9, the squares correspond to the light-receiving elements 22. Embodiment 4 differs from Embodiment 3 in that within the group of light-receiving elements 22G, different colors are associated with the central light-receiving element 22C and the left/right pair of light-receiving elements 22P that sandwich the central light-receiving element 22C. For example, the color filter 26 has one of the colors of R, G, and B for each light-receiving element 22, and colors are arranged so that either the two colors R and G or the two colors B and G alternate in the row direction and so that either the two colors R and G or the two colors B and G are adjacent in the column direction. The remaining structure is the same as in Embodiment 3.

Embodiment 4, in addition to achieving the same effects as Embodiment 1, can improve the quality of a stereoscopic image by correcting for the effect of aberration and distortion of the microlens 20. Furthermore, since R, G, and B are in a Bayer arrangement for the light-receiving elements 22, a versatile color filter not for capturing stereoscopic images may be used to configure the image pickup element 10. Hence, the cost of parts can be reduced.

### Modifications

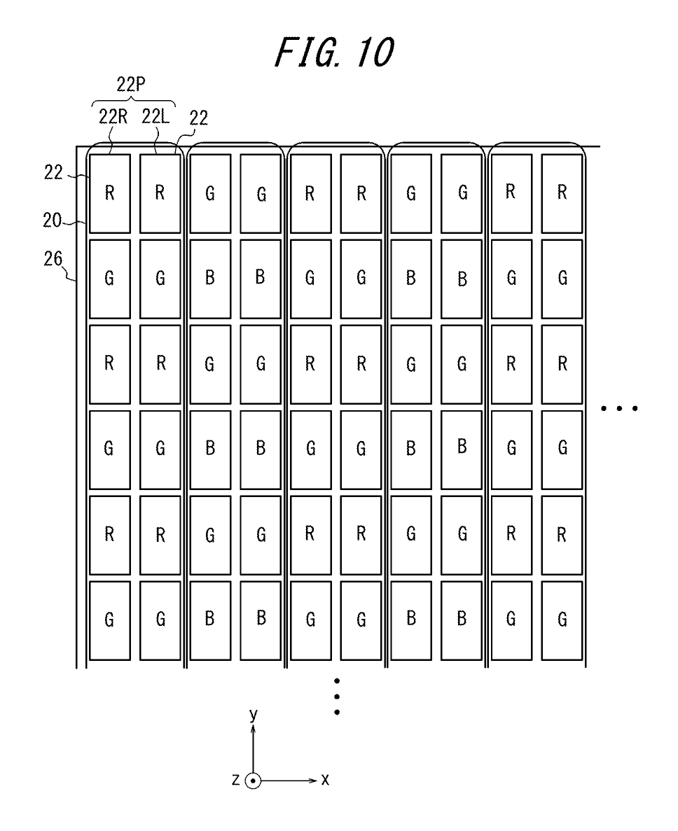

FIG. 10 illustrates a modification to Embodiment 1. This modification differs from Embodiment 1 in that the light-receiving elements 22 are narrower in the row direction than in Embodiment 1. According to this structure, a larger number of light-receiving elements 22 may be provided in the row direction, thereby improving the resolution in the width direction of a pair of captured images that have the same size as in Embodiment 1.

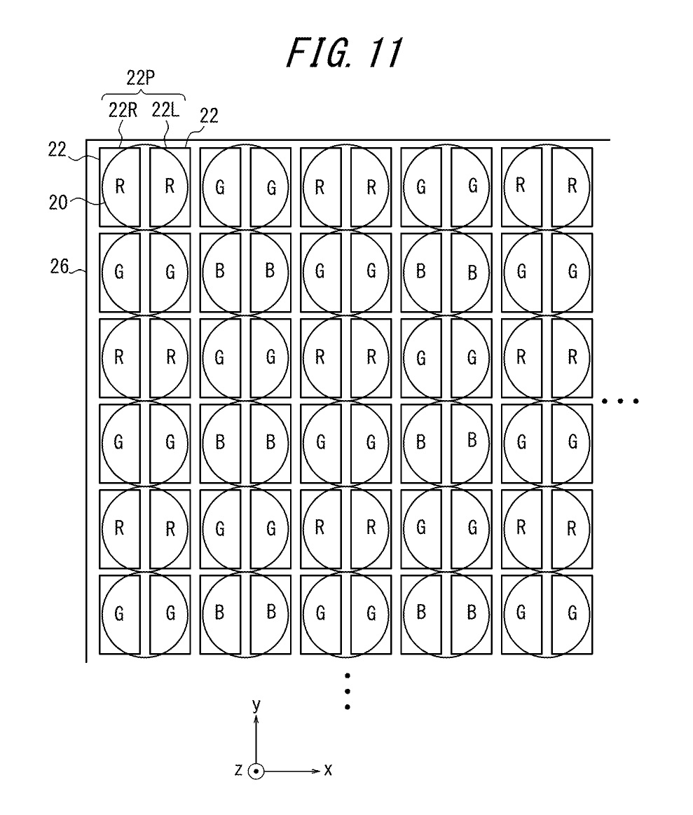

FIG. 11 illustrates another modification to Embodiment 1. This modification differs from Embodiment 1 in that the light-receiving elements 22 are narrower in the row direction than in Embodiment 1, and in that the microlenses 20 are spherical lenses rather than cylindrical lenses. Each spherical lens is disposed to cover a pair of light-receiving elements 22P. Embodiment 1 can thus be applied not only to cylindrical lenses but also to spherical lenses.

Although this disclosure is based on drawings and examples, it is to be noted that various changes and modifications will be apparent to those skilled in the art based on this disclosure. Therefore, such changes and modifications are to be understood as included within the scope of the disclosure. For example, the present disclosure includes the cases of implementing Embodiments 1 to 4 either independently or in combination. Also, the functions and the like included in the various means and the like may be reordered in any logically consistent way. Furthermore, means may be combined into one or divided.

The pair of captured images obtained from the pairs of light-receiving elements 22P in the image pickup element 10 can also, for example, be used to measure the position of an object along the z-axis by applying triangulation. The image processor 12 may, for example, perform such measurement processing.

As described above, the present embodiment allows for the prevention of a reduction in resolution and in the stereoscopic effect of a stereoscopic image.

### REFERENCE SIGNS LIST

10 Image pickup element
20 Microlens
22 Light-receiving element
22P Pair of light-receiving elements
26 Color filter
38 Wiring

1. An image pickup element comprising:
a plurality of light-receiving elements, arranged in a row direction and a column direction, that receive light from an object, a pair of light-receiving elements forming a pair in the row direction corresponding to a horizontal direction of the object and outputting pixel signals forming a pair of captured images that have parallax of the object, a group of light-receiving elements being formed by a central light-receiving element being disposed between the light-receiving elements in the pair of light-receiving elements;
a microlens that refracts light from the object and causes the light-receiving elements to receive the light;
a color filter, between the microlens and the light-receiving elements, that transmits light in accordance with color and has one color among Red (R), Green (G), and Blue (B) for each pair of light-receiving elements, two colors R and G or two colors B and G alternating in the row direction, and a different color being disposed for the pair of light-receiving elements and the central light-receiving element; and
wiring, between the light-receiving elements in the row direction, that transmits an input signal or an output signal of the light-receiving elements, wherein
the microlens is a cylindrical lens that extends in the column direction and covers the group of light-receiving elements.

2. The image pickup element of claim 1, wherein
the color filter is arranged so that two colors R and G or two colors B and G are adjacent in the column direction.

3. The image pickup element of claim 1, wherein
the wiring is disposed between pairs of the light-receiving elements in the row direction.

4. The image pickup element of claim 1, wherein
the wiring is made of copper.

5. An image pickup apparatus comprising:
the image pickup element of claim 1; and
a display configured to display a stereoscopic image based on the pairs of captured images of claim 1.

6. An image pickup apparatus comprising:
the image pickup element of claim 2; and
a display configured to display a stereoscopic image based on the pairs of captured images of claim 2.

7. An image pickup apparatus comprising:
the image pickup element of claim 3; and
a display configured to display a stereoscopic image based on the pairs of captured images of claim 3.

8. An image pickup apparatus comprising:
the image pickup element of claim 4; and
a display configured to display a stereoscopic image based on the pairs of captured images of claim 4.

9. The image pickup apparatus of claim 5, further comprising:
an amplifier configured to amplify the pixel signals output by the light-receiving elements by an amplification factor in accordance with color of the color filter and to output amplified pixel signals to the display.

10. The image pickup apparatus of claim 6, further comprising:
an amplifier configured to amplify the pixel signals output by the light-receiving elements by an amplification factor in accordance with color of the color filter and to output amplified pixel signals to the display.

11. The image pickup apparatus of claim 7, further comprising:
an amplifier configured to amplify the pixel signals output by the light-receiving elements by an amplification factor in accordance with color of the color filter and to output amplified pixel signals to the display.

12. The image pickup apparatus of claim 8, further comprising:
an amplifier configured to amplify the pixel signals output by the light-receiving elements by an amplification factor in accordance with color of the color filter and to output amplified pixel signals to the display.
